(19) United States
(12) Patent Application Publication
(10) Pub. No.: US 2025/0331634 A1
(43) Pub. Date: Oct. 30, 2025

(54) GRAVITY-ACTUATED LOCKING STRUCTURE AND PIECE OF FOLDABLE FURNITURE

(71) Applicant: Luhao LENG, Xiamen (CN)

(72) Inventor: Luhao LENG, Xiamen (CN)

(21) Appl. No.: 19/192,542

(22) Filed: Apr. 29, 2025

(30) Foreign Application Priority Data
Apr. 29, 2024 (CN) 202420922499.0

(51) Int. Cl. A47B 3/087; A47B 3/083; E05B 15/00

(52) U.S. Cl. CPC A47B 3/087; E05B 15/0093; A47B 2003/0835

(57) ABSTRACT

A gravity-actuated locking structure includes a locking buckle and a rotation shaft assembly. The locking buckle includes a position-limiting member, and the rotation shaft assembly includes a position-limiting matching member configured to be matched with the position-limiting member. When the gravity-actuated locking structure is placed in a first orientation, the locking buckle swings to a first position relative to the rotation shaft assembly due to gravity, so that the position-limiting member and the position-limiting matching member are interlocked with each other in a rotation direction of the rotation shaft assembly. When the gravity-actuated locking structure is placed in a second orientation, the locking buckle swings to a second position relative to the rotation shaft assembly due to the gravity, so that an interlocked connection in the rotation direction of the rotation shaft assembly between the position-limiting member and the position-limiting matching member is released.

### RELATED APPLICATIONS

This application claims priority to Chinese patent application number 202420922499.0, filed on Apr. 29, 2024. Chinese patent application number 202420922499.0 is incorporated herein by reference.

### FIELD OF THE DISCLOSURE

The present disclosure relates to furniture and in particular to a piece of furniture with a foldable function.

### BACKGROUND OF THE DISCLOSURE

A folding table is a table that can be folded. Due to its convenient folding capability and portability, folding tables are frequently seen in temporary reception venues such as banquets, conferences, and exhibitions, and have become indispensable furniture in hotels, exhibition halls, and similar settings.

In existing folding table technologies, the unfolding and folding mechanisms typically rely on torsion springs. In the unfolded state, the elastic force of the torsion spring keeps the latch pressed against the inner hinge. To fold the table, the latch must be pressed to release the lock. This structure requires additional manual operation, demands significant force from users during unlocking, and poses safety risks as the sudden release of force of the torsion spring may easily pinch hands of the users.

### BRIEF SUMMARY OF THE DISCLOSURE

The primary technical problem addressed by the present disclosure is to provide a gravity locking mechanism that enables locking and unlocking of the locking buckle simply by adjusting an orientation of a structure.

In order to solve the above technical problems, the present disclosure provides a gravity-actuated locking structure comprising a locking buckle and a rotation shaft assembly. The locking buckle comprises a position-limiting member, and the rotation shaft assembly comprises a position-limiting matching member configured to be matched with the position-limiting member. When the gravity-actuated locking structure is placed in a first orientation, the locking buckle swings to a first position relative to the rotation shaft assembly due to gravity, so that the position-limiting member and the position-limiting matching member are interlocked with each other in a rotation direction of the rotation shaft assembly. When the gravity-actuated locking structure is placed in a second orientation, the locking buckle swings to a second position relative to the rotation shaft assembly due to the gravity, so that an interlocked connection in the rotation direction of the rotation shaft assembly between the position-limiting member and the position-limiting matching member is released.

In a preferred embodiment, the position-limiting member is a buckle, and the position-limiting matching member is a groove. When the locking buckle is in the first position, the buckle is placed in the groove. When the locking buckle is in the second position, the buckle is separated from the groove.

In a preferred embodiment, the rotation shaft assembly comprises an inner hinge, an outer hinge, and a rotation shaft enabling the inner hinge and the outer hinge to be rotatably connected to each other.

In a preferred embodiment, the outer hinge has a cavity for receiving one end of the inner hinge, and a side wall of the cavity comprises a first connecting hole. The one end of the inner hinge comprises a second connecting hole configured to be matched with the first connecting hole, and the rotation shaft passes through the first connecting hole and the second connecting hole.

In a preferred embodiment, one or more inner side walls of the cavity comprise one or more protrusions extending along a thickness direction of the cavity, and the one end of the inner hinge comprises one or more holes configured to be matched with the one or more protrusions.

In a preferred embodiment, the one or more holes are divided into two groups of holes. When the outer hinge is rotated relative to the inner hinge to an unfolded state or a folded state, the one or more protrusions are respectively placed in different groups of the two groups of holes.

In a preferred embodiment, the groove is arranged in a part of the one end of the inner hinge which is placed in the outer hinge, and the locking buckle is disposed between two inner side walls of the cavity.

In a preferred embodiment, the rotation shaft is a bolt and a nut connected to a distal end of the bolt.

The present disclosure provides a piece of foldable furniture comprising a first part, a second part, and the gravity-actuated locking structure. The gravity-actuated locking structure is configured to connect the first part and the second part. When the locking buckle of the gravity-actuated locking structure is in the first position, the first part and the second part are in a locked and fixed state. When the locking buckle is in the second position, the first part and the second part are in a relatively rotatable state.

In a preferred embodiment, the piece of foldable furniture is a table, and the first part and the second part are two desktops.

Compared with the existing techniques, the technical solution has the following advantages.

The present disclosure provides the gravity-actuated locking structure. By changing a placement direction of the gravity-actuated locking structure, the locking buckle can swing due to gravity to switch between a locked state and an unlocked state, eliminating a need for additional user operations to achieve locking or unlocking.

The present disclosure further discloses the gravity-actuated locking structure. The rotation shaft assembly incorporates the one or more protrusions to increase a friction between the outer hinge and the inner hinge, thereby creating a damping effect. When the outer hinge is rotated relative to the inner hinge to reach either the unfolded state or the folded state, the one or more protrusions are positioned in different sets of holes. This design ensures that the damping effect is only active during rotation of the inner hinge relative to the outer hinge. Once rotation is complete, the one or more protrusions are disposed in a corresponding set of holes.

### BRIEF DESCRIPTION OF THE DRAWINGS

FIG. 1 is a perspective view of a preferred embodiment in an unfolded state.

FIG. 2 is a side view of the preferred embodiment in the unfolded state.

FIG. 3 is a perspective view of the preferred embodiment in a folded state.

FIG. 4 is a perspective view of a gravity-actuated locking structure placed in a first orientation.

FIG. 5 is a cross-sectional view of the gravity-actuated locking structure placed in the first orientation.

FIG. 6 is a perspective view of the gravity-actuated locking structure placed in a second orientation.

FIG. 7 is a schematic diagram of the gravity-actuated locking structure in the folded state when placed in the second orientation.

FIG. 8 is a perspective view of an outer hinge in the preferred embodiment.

FIG. 9 is a top view of the outer hinge in the preferred embodiment.

FIG. 10 is a perspective view of an inner hinge in the preferred embodiment.

FIG. 11 is a top view of the inner hinge in the preferred embodiment.

FIG. 12 is a schematic diagram illustrating a connection between the inner hinge and outer hinge in the preferred embodiment.

### DETAILED DESCRIPTION OF THE EMBODIMENTS

The following will clearly and completely describe the technical solutions in the embodiments of the present disclosure with reference to the accompanying drawings. Obviously, the described embodiments are only a portion of the embodiments of the present disclosure, and not all of the embodiments. Based on the embodiments of the present disclosure, all other embodiments obtained by those of ordinary skill in the art without creative work fall within the protection scope of the present disclosure.

In the description of the present disclosure, it should be noted that directional or positional relationships indicated by terms such as “upper”, “lower”, “inner”, “outer”, “upper end”, and “lower end” are based on orientations or positional relationships shown in the accompanying drawings. These terms are used solely to facilitate the description of the present disclosure and simplify the explanation, rather than to indicate or imply that the referenced devices or components must have specific orientations or be constructed and operated in specific orientations. Therefore, they should not be construed as limiting the present disclosure. Additionally, terms such as “first” and “second” are used for descriptive purposes only and should not be interpreted as indicating or implying relative importance.

In the description of this application, it should be noted that unless otherwise explicitly specified and defined, terms such as “install”, “provided with”, “sleeved”, “connected”, and “connect” should be interpreted broadly. For example, “connection” may refer to wall-mounted connections, detachable connections, integrated connections, mechanical connections, or electrical connections. It may indicate direct connections or indirect connections through intermediary media, and may involve internal communication between two components. For those of ordinary skill in the art, the specific meanings of the above terms in the present disclosure can be understood according to actual circumstances.

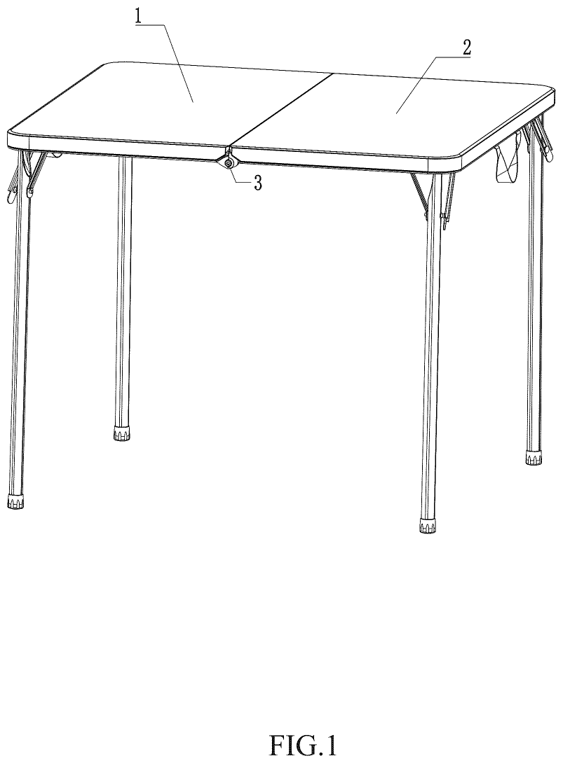

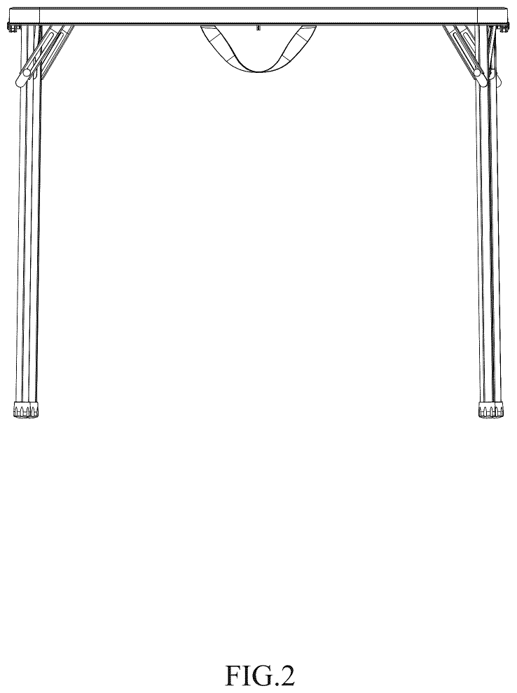

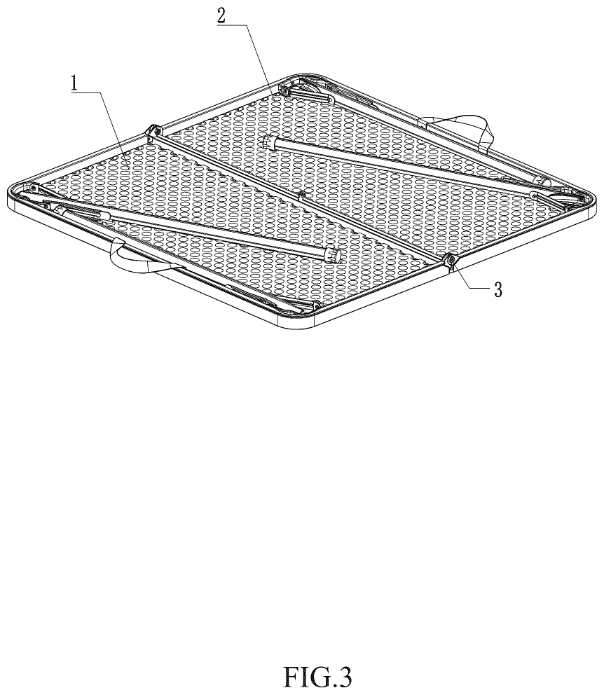

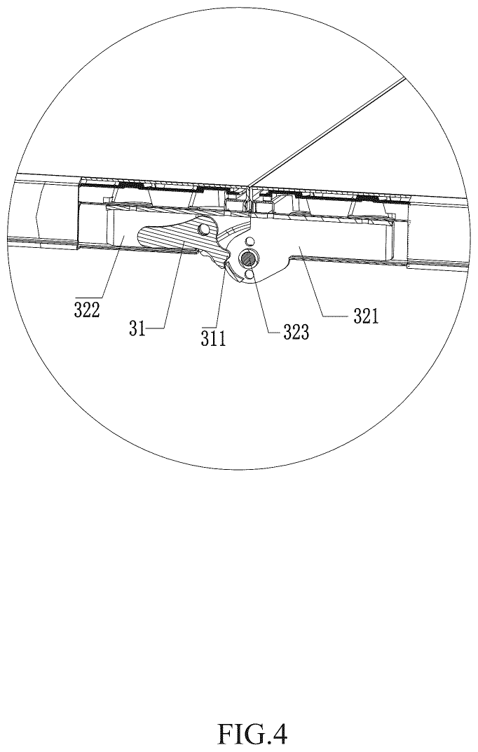

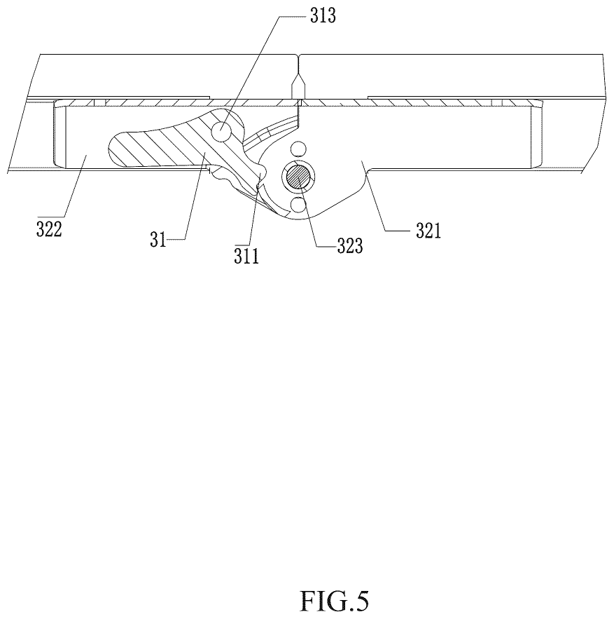

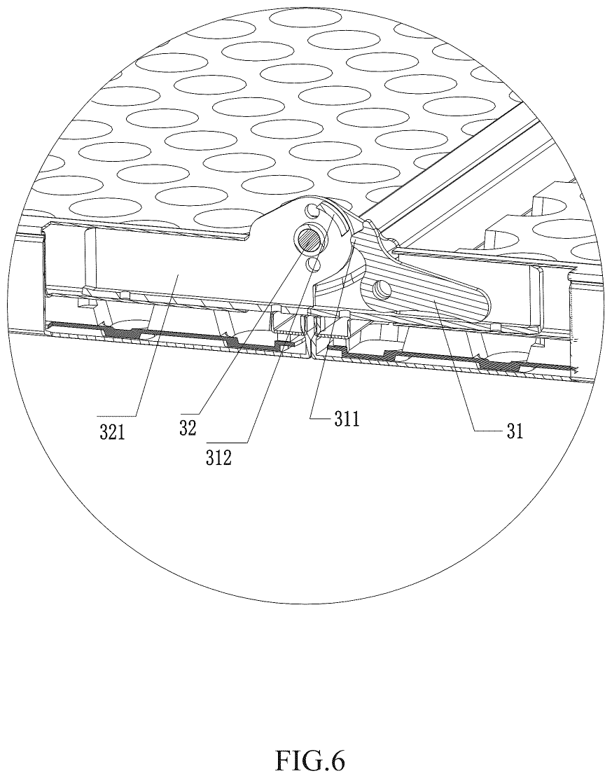

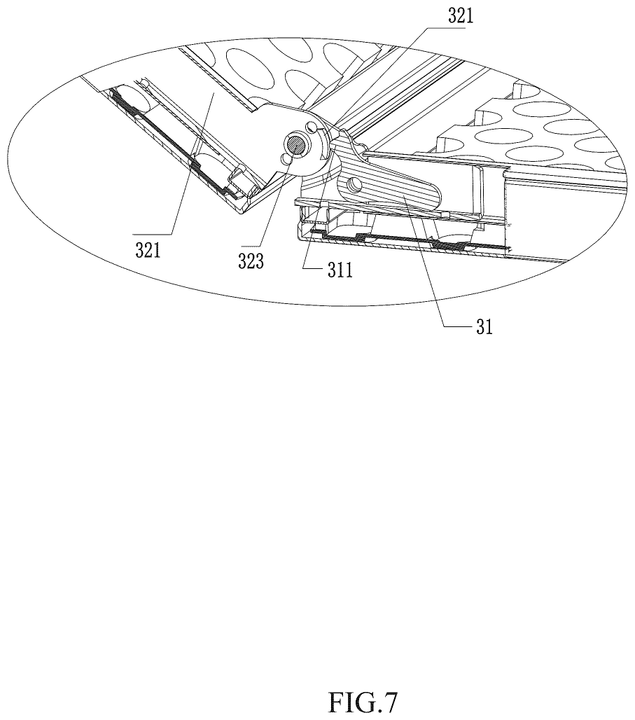

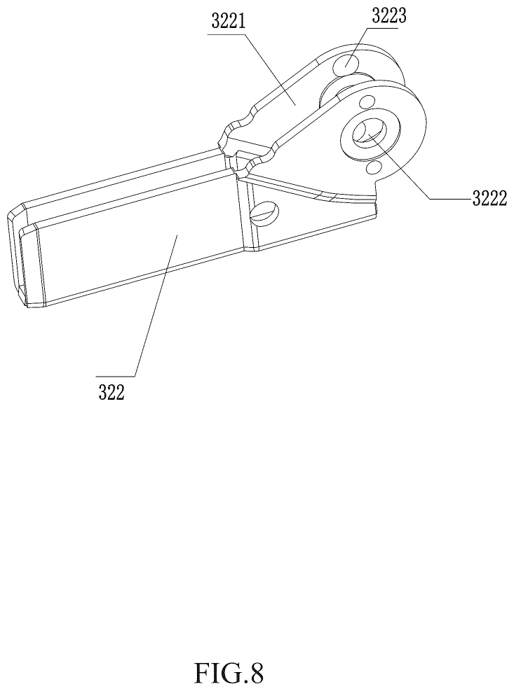

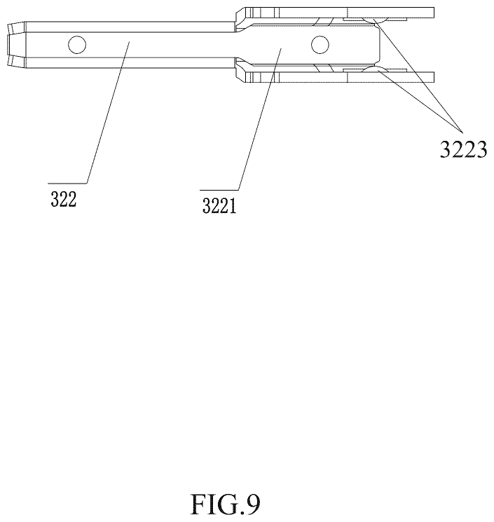

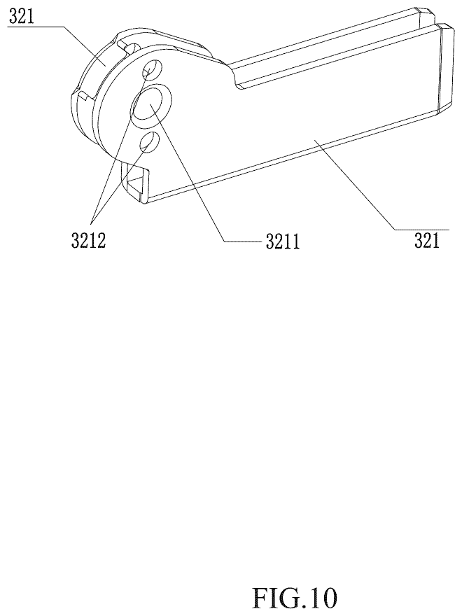

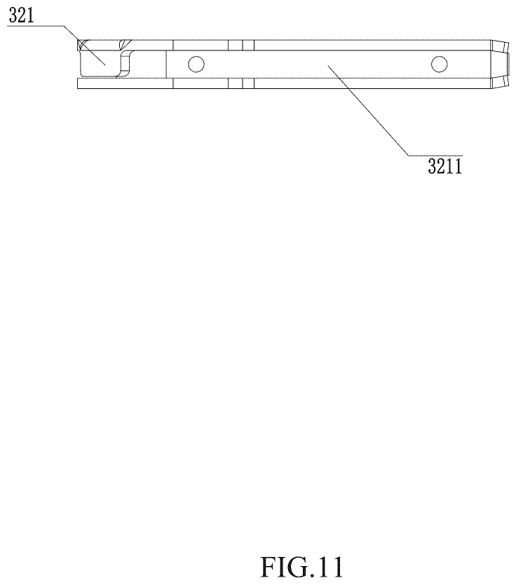

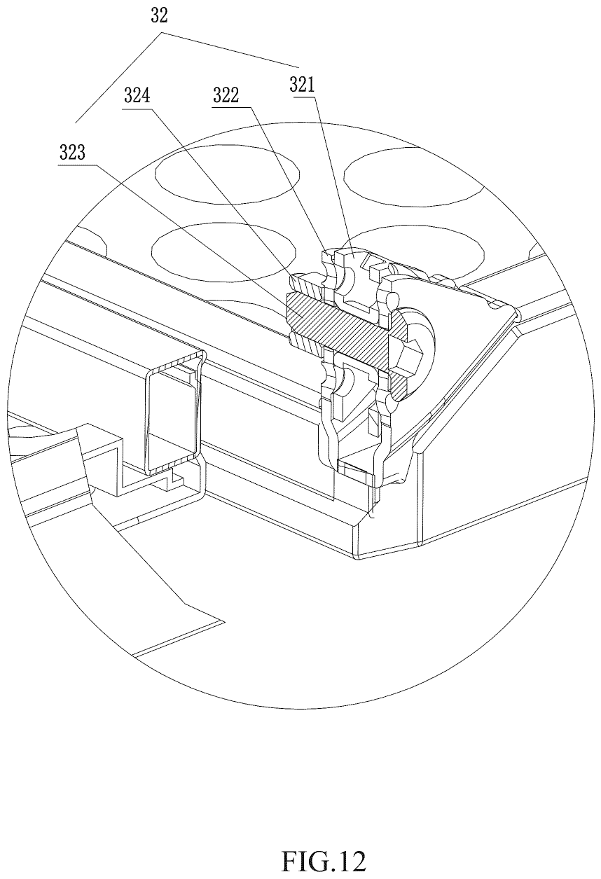

Referring to FIGS. 1 to 12, the present embodiment provides a foldable table, and the foldable table comprises a first part 1, a second part 2, and a gravity-actuated locking structure 3. In this embodiment, the first part 1 and the second part 2 are two desktops, and the gravity-actuated locking structure 3 is configured to connect the first part 1 and the second part 2. When a locking buckle 31 of the gravity-actuated locking structure 3 is in a first position, the first part 1 and the second part 2 are in a locked and fixed state, the two desktops are spliced to form a large desktop, and the foldable table is in an unfolded state and locked in the unfolded state. When the locking buckle 31 is in a second position, the first part 1 and the second part 2 are in a relatively rotatable state, the user can make the two desktops approach each other through a relative rotation of the first part 1 and the second part 2, and the foldable table can be folded and stored.

Therefore, the gravity-actuated locking structure 3 enables the locking buckle 31 to be located in the first position or the second position by simply changing a placement direction of the gravity-actuated locking structure 3. Thus, locking and unlocking of the gravity-actuated locking structure 3 are realized. In this embodiment, a first orientation refers to a use surface of the desktop facing away from to ground. A second orientation refers to the use surface of the desktop facing the ground.

In order to achieve the above-mentioned effects, the gravity-actuated locking structure 3 in this embodiment comprises the locking buckle 31 and a rotation shaft assembly 32. The locking buckle 31 comprises a position-limiting member 311, and the rotation shaft assembly 32 comprises a position-limiting matching member 312 configured to be matched with the position-limiting member 311.

When the gravity-actuated locking structure 3 is placed in the first orientation, the locking buckle 31 swings to the first position relative to the rotation shaft assembly 32 due to gravity, so that the position-limiting member 311 and the position-limiting matching member 312 are interlocked with each other in a rotation direction of the rotation shaft assembly 32. When the gravity-actuated locking structure 3 is placed in the second orientation, the locking buckle 31 swings to the second position relative to the rotation shaft assembly 32 due to the gravity, so that an interlocked connection in the rotation direction of the rotation shaft assembly 32 between the position-limiting member 311 and the position-limiting matching member 312 is released. In this way, the user can unlock the gravity-actuated locking structure 3 by simply turning over the foldable table, and then the first part 1 and the second part 2 can be relatively rotated so as to fold the foldable table for storage.

In this embodiment, the position-limiting member 311 is a buckle, and the position-limiting matching member 312 is a groove. When the locking buckle 31 is in the first position, the buckle is placed in the groove. When the locking buckle 31 is in the second position, the buckle is separated from the groove. When the buckle is placed in the groove and the first part 1 and the second part 2 are going to move relative to each other, movement of the buckle will be inhibited by the groove to generate a position-limiting force in an opposite direction of relative movement of the first part 1 and the second part 2, thereby maintaining the first part 1 and the second part 2 in the locked and fixed state. When the buckle is separated from the groove, the position-limiting force disappears, and the first part 1 and the second part 2 are released from the locked and fixed state and can be rotated freely.

In this embodiment, the rotation shaft assembly 32 comprises an inner hinge 321, an outer hinge 322, and a rotation shaft enabling the inner hinge 321 and the outer hinge 322 to be rotatably connected to each other. The outer hinge 322 has a cavity 3221 for receiving one end of the inner hinge 321, and a side wall of the cavity 3221 comprises a first connecting hole 3222. The one end of the inner hinge 321 comprises a second connecting hole 3211 configured to be matched with the first connecting hole 3222. In this embodiment, the rotation shaft is a bolt 323, and the bolt 323 passes through the first connecting hole 3222 and the second connecting hole 3211. A nut 324 is connected to a distal end of the bolt 323, so that the bolt 323 is fixed in the first connecting hole 3222 and the second connecting hole 3211.

In this embodiment, the groove is arranged in a part of the one end of the inner hinge 321 which is placed in the outer hinge 322. The locking buckle 31 is disposed between two inner side walls of the cavity 3221. The locking buckle 31 is connected to the two inner side walls of the cavity 3221 through a pin 313, so that the locking buckle 31 can swing relative to the cavity 3221. As long as an area of the cavity 3221 is larger than an area of the locking buckle 31, a swinging space can be provided for the locking buckle 31. Thereby, the placement direction of the foldable table can be changed to enable the locking buckle 31 to swing to change a position of the locking buckle 31 due to the gravity.

In addition, in order to increase a friction force between the inner hinge 321 and the outer hinge 322 when rotating to achieve a rotation damping effect, the two inner side walls of the cavity 3221 comprise two protrusions 3223 extending along a thickness direction of the cavity 3221. A gap between the two protrusions 3223 is smaller than a thickness of the one end of the inner hinge 321, so that during a rotation of the inner hinge 321 relative to the outer hinge 322, the two protrusion 3223 will be squeezed by an outer wall of the inner hinge 321 to generate the friction force, thereby achieving the rotation damping effect of the rotation shaft.

In addition, the outer wall of one end of the inner hinge 321 comprises two holes 3212 configured to be matched with the two protrusions 3223, and two sets of the two holes 3212 are provided. When the outer hinge 322 is rotated relative to the inner hinge 321 to an unfolded state or a folded state, the two protrusions 3223 are respectively placed in different sets of the two holes 3212. In this way, the rotation damping effect is formed only when the inner hinge 321 is rotated relative to the outer hinge 322, and after the rotation is in place, the two protrusions 3223 enter one of two sets of the two holes 3212 to achieve positioning and matching.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A gravity-actuated locking structure, comprising:
a locking buckle, and
a rotation shaft assembly, wherein:
the locking buckle comprises a position-limiting member,
the rotation shaft assembly comprises a position-limiting matching member configured to be matched with the position-limiting member,
when the gravity-actuated locking structure is placed in a first orientation, the locking buckle swings to a first position relative to the rotation shaft assembly due to gravity, so that the position-limiting member and the position-limiting matching member are interlocked with each other in a rotation direction of the rotation shaft assembly, and
when the gravity-actuated locking structure is placed in a second orientation, the locking buckle swings to a second position relative to the rotation shaft assembly due to the gravity, so that an interlocked connection in the rotation direction of the rotation shaft assembly between the position-limiting member and the position-limiting matching member is released.

2. The gravity-actuated locking structure according to claim 1, wherein:
the position-limiting member is a buckle,
the position-limiting matching member is a groove,
when the locking buckle is in the first position, the buckle is placed in the groove, and
when the locking buckle is in the second position, the buckle is separated from the groove.

3. The gravity-actuated locking structure according to claim 2, wherein:
the rotation shaft assembly comprises an inner hinge, an outer hinge, and a rotation shaft enabling the inner hinge and the outer hinge to be rotatably connected to each other.

4. The gravity-actuated locking structure according to claim 3, wherein:
the outer hinge has a cavity for receiving one end of the inner hinge,
a side wall of the cavity comprises a first connecting hole,
the one end of the inner hinge comprises a second connecting hole configured to be matched with the first connecting hole, and
the rotation shaft passes through the first connecting hole and the second connecting hole.

5. The gravity-actuated locking structure according to claim 4, wherein:
one or more inner side walls of the cavity comprise one or more protrusions extending along a thickness direction of the cavity, and
the one end of the inner hinge comprises one or more holes configured to be matched with the one or more protrusions.

6. The gravity-actuated locking structure according to claim 5, wherein:
the one or more holes are divided into two groups of holes, and
when the outer hinge is rotated relative to the inner hinge to an unfolded state or a folded state, the one or more protrusions are respectively placed in different groups of the two groups of holes.

7. The gravity-actuated locking structure according to claim 4, wherein:
the groove is arranged in a part of the one end of the inner hinge which is placed in the outer hinge, and
the locking buckle is disposed between two inner side walls of the cavity.

8. The gravity-actuated locking structure according to claim 3, wherein:
the rotation shaft is a bolt and a nut connected to a distal end of the bolt.

9. A piece of foldable furniture, comprising:
a first part,
a second part, and
the gravity-actuated locking structure according to claim 1, wherein:
the gravity-actuated locking structure is configured to connect the first part and the second part,
when the locking buckle of the gravity-actuated locking structure is in the first position, the first part and the second part are in a locked and fixed state, and
when the locking buckle is in the second position, the first part and the second part are in a relatively rotatable state.

10. The piece of foldable furniture according to claim 9, wherein:
the piece of foldable furniture is a table, and
the first part and the second part are two desktops.

11. A piece of foldable furniture, comprising:
a first part,
a second part, and
the gravity-actuated locking structure according to claim 2, wherein:
the gravity-actuated locking structure is configured to connect the first part and the second part,
when the locking buckle of the gravity-actuated locking structure is in the first position, the first part and the second part are in a locked and fixed state, and
when the locking buckle is in the second position, the first part and the second part are in a relatively rotatable state.

12. A piece of foldable furniture, comprising:
a first part,
a second part, and
the gravity-actuated locking structure according to claim 3, wherein:
the gravity-actuated locking structure is configured to connect the first part and the second part,
when the locking buckle of the gravity-actuated locking structure is in the first position, the first part and the second part are in a locked and fixed state, and
when the locking buckle is in the second position, the first part and the second part are in a relatively rotatable state.

13. A piece of foldable furniture, comprising:
a first part,
a second part, and
the gravity-actuated locking structure according to claim 4, wherein:
the gravity-actuated locking structure is configured to connect the first part and the second part,
when the locking buckle of the gravity-actuated locking structure is in the first position, the first part and the second part are in a locked and fixed state, and
when the locking buckle is in the second position, the first part and the second part are in a relatively rotatable state.

14. A piece of foldable furniture, comprising:
a first part,
a second part, and
the gravity-actuated locking structure according to claim 5, wherein:
the gravity-actuated locking structure is configured to connect the first part and the second part,
when the locking buckle of the gravity-actuated locking structure is in the first position, the first part and the second part are in a locked and fixed state, and
when the locking buckle is in the second position, the first part and the second part are in a relatively rotatable state.

15. A piece of foldable furniture, comprising:
a first part,
a second part, and
the gravity-actuated locking structure according to claim 6, wherein:
the gravity-actuated locking structure is configured to connect the first part and the second part,
when the locking buckle of the gravity-actuated locking structure is in the first position, the first part and the second part are in a locked and fixed state, and
when the locking buckle is in the second position, the first part and the second part are in a relatively rotatable state.

16. A piece of foldable furniture, comprising:
a first part,
a second part, and
the gravity-actuated locking structure according to claim 7, wherein:
the gravity-actuated locking structure is configured to connect the first part and the second part,
when the locking buckle of the gravity-actuated locking structure is in the first position, the first part and the second part are in a locked and fixed state, and
when the locking buckle is in the second position, the first part and the second part are in a relatively rotatable state.

17. A piece of foldable furniture, comprising:
a first part,
a second part, and
the gravity-actuated locking structure according to claim 8, wherein:
the gravity-actuated locking structure is configured to connect the first part and the second part,
when the locking buckle of the gravity-actuated locking structure is in the first position, the first part and the second part are in a locked and fixed state, and
when the locking buckle is in the second position, the first part and the second part are in a relatively rotatable state.
